(19) United States
(12) Patent Application Publication
(10) Pub. No.: US 2010/0330937 A1
(43) Pub. Date: Dec. 30, 2010

(54) FM SIGNAL TRANSMITTER AND AUDIO FILTERING METHOD

(75) Inventors: Sampson Soo, Kowloon (CN); Hsien-Hong Wei, Chupei City (TW)

Correspondence Address: RABIN & Berdo, PC, 1101 14TH STREET, NW, SUITE 500, WASHINGTON, DC, 20005, US

(73) Assignees: KING BILLION ELECTRONICS CO., LTD., Hsinchu Hsien (TW); KOONER TECHNOLOGY (HK) CO., LTD., Kowloon (HK)

(21) Appl. No.: 12/492,576

(22) Filed: Jun. 26, 2009

(51) Int. Cl. H04B 1/04; G06F 17/00

(52) U.S. Cl. 455/113; 700/94

(57) ABSTRACT

An FM signal transmitter has a processing module, a connecting module and an FM transmitting module. The connecting module is electronically connected to the processing module and has a Universal Serial Bus (USB) unit that is selectively connected to a computer and receives audio data from the computer, wherein the USB unit has a memory storing a preset USB class. The FM transmitting module is electronically connected to and controlled by the processing module to broadcast an FM signal corresponding to the audio data under a specific frequency. The computer may perform an audio filtering method to successively rewrite the preset USB class from USB-HID, USB-AUDIO and USB-HID so that the computer can transmit audio data excluding system generated sounds to the FM signal transmitter.

### BACKGROUND OF THE INVENTION

1. Field of Invention

The present invention relates to a frequency modulation (FM) signal transmitter, and more particularly to an FM signal transmitter connected to a computer.

2. Description of the Related Art

Listening to FM radio broadcasts is very popular in many countries, especially in Europe. Now many radio stations synchronously transmit music signals over the Internet. Therefore, by accessing the Internet many worldwide radio stations are available, instead of a limited numbers of broadcast FM radio stations and sound quality is higher.

However, using the Internet to listen to radio channels is not convenient since computers connected to the Internet are not easily portable or relocated. Moreover, when multiple members in different rooms like to listen radio channels over the Internet, each one of them has to turn on their personal computer so consumes far greater energy than using radios. The present invention provides an FM signal transmitter for connection to a computer to broadcast an FM signal of an audio signal from the computer.

### SUMMARY OF THE INVENTION

The primary objective of the present invention is to provide an FM signal transmitter for connection to a computer to broadcast an FM signal of an audio signal from the computer.

The FM signal transmitter has a processing module, a connecting module and an FM transmitting module. The connecting module is electronically connected to the processing module and comprises a Universal Serial Bus (USB) unit that is selectively connected to a computer and receives audio data from the computer, where the USB unit has a memory storing a preset USB class. The FM transmitting module is electronically connected to and controlled by the processing module to broadcast an FM signal corresponding to the audio data under a specific frequency. The computer may perform an audio filtering method to successively rewrite the preset USB class from USB-HID, USB-AUDIO and USB-HID so that the computer can transmit audio data excluding system generated sounds to the FM signal transmitter.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an FM signal transmitter in accordance of the present invention; and

FIG. 2 is a flow chart of an audio filtering method in accordance with the present invention.

### DETAILED DESCRIPTION OF THE INVENTION

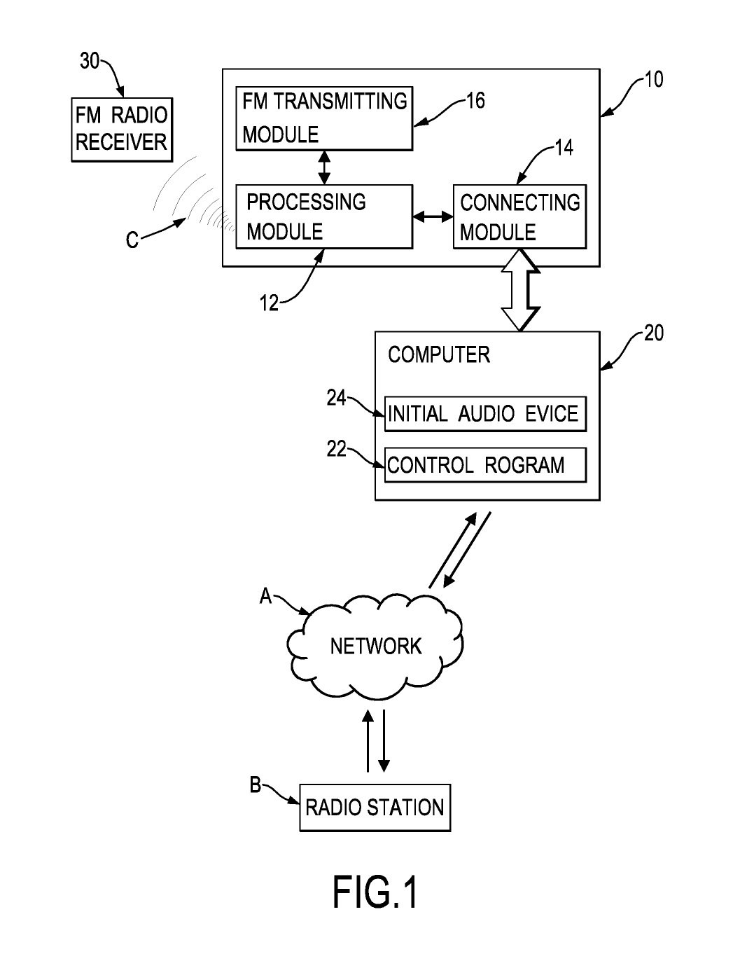

With reference to FIG. 1, an FM signal transmitter (10) in accordance with the present invention comprises a processing module (12), a connecting module (14) and an FM transmitting module (16).

The connecting module (14) is electronically connected to the processing module (12) and comprises a Universal Serial Bus (USB) unit. The USB unit has a memory, where the memory stores a preset USB class. The preset USB class functions as identification of the FM signal transmitter (10) to a computer (20) when the connecting module (14) is connected to the computer (20). USB standards define USB class codes to identify a function of a device to allow a device driver based on that function to be loaded. The preset USB class may be a USB-HID (USB human interface device), a USB-AUDIO or a USB-AUDIO+USB-HID composite device so that the computer (20) automatically sets the FM signal transmitter (10) as a USB-HID, USB-AUDIO or the USB-AUDIO+USB-HID device accordingly when the connecting module (14) is plugged into a USB port of the computer (20). The connecting module (14) is controlled by the processing module (12) to receive audio data from the computer (20).

The computer (20) may receive audio data signal broadcast by a radio station (B) via a network (A), the network (A) may be the Internet, an intranet or the like. The computer (20) transforms the audio data signal into the audio data and transmits the audio data to the connecting module (14).

The FM transmitting module (16) is electronically connected to and controlled by the processing module (12) to broadcast an FM signal (C) at a specific frequency based on the audio data.

Therefore, an FM radio receiver (30) may be used to receive the FM signal (C) and listen to the audio data. The FM radio receiver (30) has an FM receiver and may be a miniature or standard radio, cell phone, MP3 player or the like.

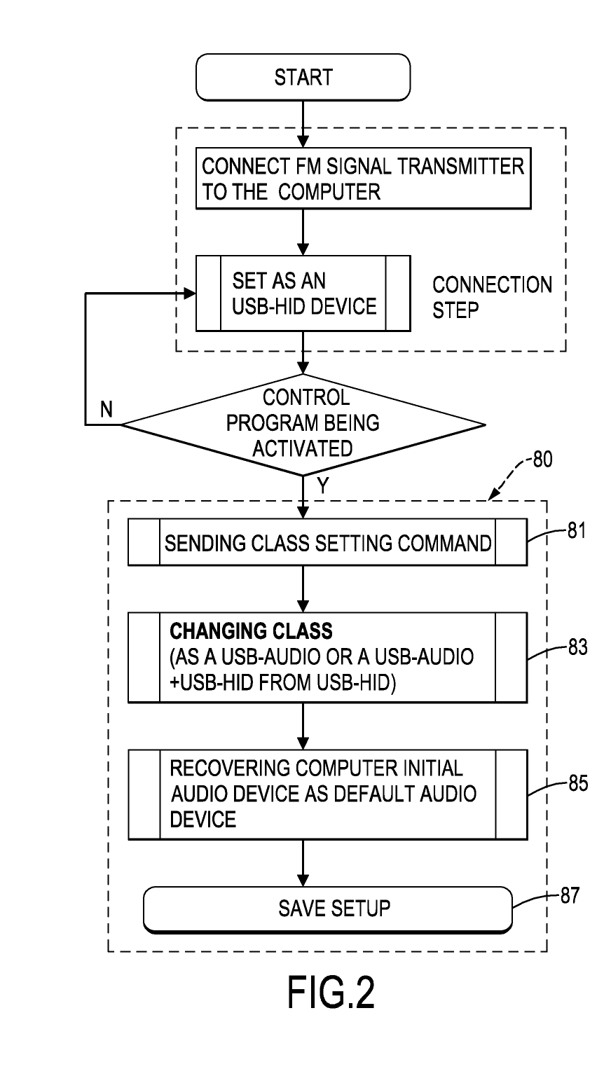

When the preset USB class of the FM signal transmitter (10) is USB-AUDIO or USB-AUDIO+USB-HID, the computer (20) automatically sets the FM signal transmitter (10) as a default audio device when the FM signal transmitter (19) is plugged into the USB port of the computer (20). Therefore, the audio data sent to the FM signal transmitter (10) will also include all system generated sounds, such as caution beeps. With reference to FIG. 2, therefore the preset USB class of the FM signal transmitter (10) is preferably set as USB-HID so the computer (20) will remain an initial audio device (24) be the default audio device when the FM signal transmitter (10) is plugged therein.

The computer (20) may have a control program (22) that is used to activate the computer (20) to transmit the audio data to the FM signal transmitter (10). The control program (22) performs an audio filtering method (80) comprising steps of sending class setting command (81), changing class (83), recovering computer initial audio device as default audio device (85), and saving setup (87). The control program (22) may be an add-on object for a program that is able to receive or play the vocal or music signal and may have an activate button. When the activate button of the control program (22) is actuated, the audio filtering method (80) is performed.

In the step of sending class setting command (81), the control program (22) generates and sends a class setting command to the FM signal transmitter (10).

In the step of changing class (83), the processing module (12) receives the class setting command via the connecting module (14) and rewrites the preset USB class in the memory from a USB-HID to a USB-AUDIO or a USB-AUDIO+USB-HID. Thus, the computer (20) detects a new USB-AUDIO device and sets the FM signal transmitter (10) as the default audio device.

In the step of recovering computer initial audio device as default audio device (85), the control program (22) automatically recovers the initial audio device (24) as the default audio device of the computer (20) system.

In the step of saving setup (87), the control program (22) saves information about the FM signal transmitter (10) that may selectively be a USB-AUDIO or a USB-AUDIO+USB-HID device, so the control program (22) may become an interconnection for the computer (20) and the FM signal transmitter (10) and transmits the audio data to the FM signal transmitter (10).

The control program (22) may be an add-on for Microsoft Explorer (IE) as an example, after the activate button has been actuated, the audio filtering method (80) is performed automatically as described. Then IE is used to select one FM radio station (B) to receive the audio data signal. The control program (22) generates and continuously transmits the audio data to the FM signal transmitter (10) and the FM signal transmitter (10) broadcasts the FM signal (C) wirelessly at the specific frequency. Thus, different FM radio receivers (30) can be used to receive and listen to the audio data.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An FM signal transmitter having
a processing module;
a connecting module electronically connected to the processing module and comprising a Universal Serial Bus (USB) unit that is selectively connected to a computer and receives audio data from the computer, wherein the USB unit has a memory storing a preset USB class; and
an FM transmitting module electronically connected to and controlled by the processing module to broadcast an FM signal corresponding to the audio data under a specific frequency.

2. The FM signal transmitter as claimed in claim 1, wherein the preset USB class is a USB-HID class and is successively changed to a USB-AUDIO class and a USB-HID class.

3. The FM signal transmitter as claimed in claim 1, wherein the preset USB class is a USB-HID class and is successively changed to a USB-AUDIO+USB-HID class and a USB-HID class.

4. An audio filtering method that is performed by a computer, wherein the computer is connected to an FM signal transmitter via a USB interface, the FM signal transmitter comprises a memory storing a changeable preset USB-HID class, the audio filtering method comprises steps of:
sending class setting command, wherein the computer sends a class setting command to the FM signal transmitter;
changing class, wherein the FM signal transmitter overwrites the preset USB-HID class by a USB-AUDIO or a USB-AUDIO+USB-HID class and the computer sets the FM signal transmitter as a default audio device thereof; and
recovering computer initial audio device as default audio device, wherein the computer automatically recovers an initial audio device thereof as the default audio device.
